(19) United States
(12) Patent Application Publication
(10) Pub. No.: US 2018/0314512 A1
(43) Pub. Date: Nov. 1, 2018

(54) SOFTWARE UPDATING DEVICE

(71) Applicant: Otis Elevator Company, Farmington, CT (US)

(72) Inventor: Uwe Schonauer, Berlin (DE)

(21) Appl. No.: 15/767,507

(22) PCT Filed: Oct. 15, 2015
(86) PCT No.: PCT/EP2015/073886

§ 371 Date: Apr. 11, 2018

(51) Int. Cl. G06F 8/65; H04L 29/06; H04L 9/30; H04W 12/10; H04L 29/08

(52) U.S. Cl. CPC G06F 8/65; H04L 63/0428; H04L 67/34; H04L 63/123; H04W 12/10; H04L 9/30

(57) ABSTRACT

A mobile updating device (34) for updating the software of a people conveyor (10), the mobile updating device (34) comprising: a first data transmission interface (33), which is configured for receiving encrypted data; a decryption unit (35), which is configured for decrypting the received encrypted data; and a second data transmission interface (37), which is configured for connecting with a control unit (36) of the people conveyor (10) and to transmit the decrypted data to the control unit (36).

The present invention relates to a method of updating software in a people conveyor system, particularly in an elevator system, an escalator or a moving walkway. The present invention also relates to a mobile updating device for updating software in a people conveyor system, particularly in an elevator system, and to a system comprising such a mobile updating device.

People conveyor systems are subject to particular safety requirements. Therefore, hardware or software used to control operation of people conveyors is to a significant part subject to specific conditions in order to meet such safety requirements. Different levels of safety integrity requirements exist, depending on the degree of safety relevance of the respective functions or operations of the people conveyor system controlled. For a general overview of these safety requirements, reference is made to international standards IEC 61508-1 through IEC 61508-3.

Elevator systems are a particular example of a people conveyor system. A further example would be escalators or moving walkways. In the following, the invention will be described using an elevator system as an exemplary embodiment for a people conveyor system. It is, however, to be understood that corresponding considerations apply with respect to an escalator or moving walkway as well.

In people conveyor systems safety critical operations are controlled, or at least monitored, using sensor and/or switching devices (in the following simply referred to as safety switches) connected to a safety controller (in the following also referred to as a safety unit). Safety switches are often used at the various “safety points”, at which the state of safety critical components (e.g. the position of movable components, such as doors) must be monitored prior to the initiation of an action and, if necessary, during the course of this action. In typical configurations a number of these safety switches are, in particular, connected in series to form a so-called “safety chain” so that the action can only be started or continued when all the safety switches or, in more general terms, switching devices take up a predetermined switching state. For example, in the case of an elevator system it must be ensured that before the start and during the travel of the elevator car all doors (car doors as well as landing doors on each floor) remain closed and mechanically locked. Therefore, travel of an elevator car is in general not allowed unless all of the safety switches in a safety chain connecting respective safety switches monitoring the closing state of the doors are closed.

Nowadays a safety-unit as described herein typically involves software to control its operation and to monitor correct functioning of the unit and the safety switches connected. Specific test protocols have been developed for testing correct functioning of the safety switches used in the safety chain of a people conveyor. The procedures determining when and how to carry out such test protocols, and how to evaluate the results of the test protocols are controlled by specific safety-related software residing in a safety unit to which the switches of the safety chain are connected and which controls operation and status of the safety chain. Such software is certified to perform specific safety-related functions. Programming of such safety-related software requires extreme care, e.g. typically any functions provided need to provide redundancy.

There is a requirement of updating such safety-related software in a people conveyor system from time to time. The new software may be transmitted to the people conveyor system via a wireless and/or wire-bound network. This facilitates the updating process, as no data carriers comprising the appropriate software, which already may be outdated when the data carrier used, is needed. However, transmitting the software via a network includes the risk of the software being spied, stolen or modified. Thus, special care needs to be taken when updating such safety-related software.

It therefore would be beneficial to provide means which allow to update the software of an elevator system easily but also securely.

According to an exemplary embodiment of the invention, a method of updating the software of a people conveyor comprises the steps of:
(a) establishing a first data transmission connection between an update server and a mobile updating device;
(b) transmitting encrypted data from the update server to the mobile updating device;
(c) decrypting the data in the mobile updating device;
(d) establishing a second data transmission connection between the people conveyor and the mobile updating device; and
(e) transmitting the decrypted data from the mobile updating device to the people conveyor.

It is evident that step (d) of establishing the second data transmission connection may be performed before any of steps (a), (b), and (c), as well.

The method of updating the software may also comprise storing the encrypted data received from the server on the the mobile updating device to be decrypted and transmitted to the people conveyor later.

According to an exemplary embodiment of the invention, a mobile updating device, which is configured for updating the software of a people conveyor, comprises:
(A) a first interface, which is configured for receiving encrypted data;
(B) a decryption unit, which is configured for decrypting the received encrypted data; and
(C) a second interface, which is configured for connecting with a control unit of the people conveyor and to transmit the decrypted data to the control unit.

Transmitting the software encrypted prevents the software from being spied or stolen. Only an authorized user will be able to decrypt the transmitted data in order to install the new software. Unauthorized users do not possess the key, which is necessary for decrypting the encrypted data, and therefore will not be able to decrypt, study and/or install the software.

Although a mobile updating device and a method of updating the software of a people conveyor according to exemplary embodiments of the invention are in particular useful for updating safety related software, it is evident that they are not restricted thereto but may be used for updating any kind of software.

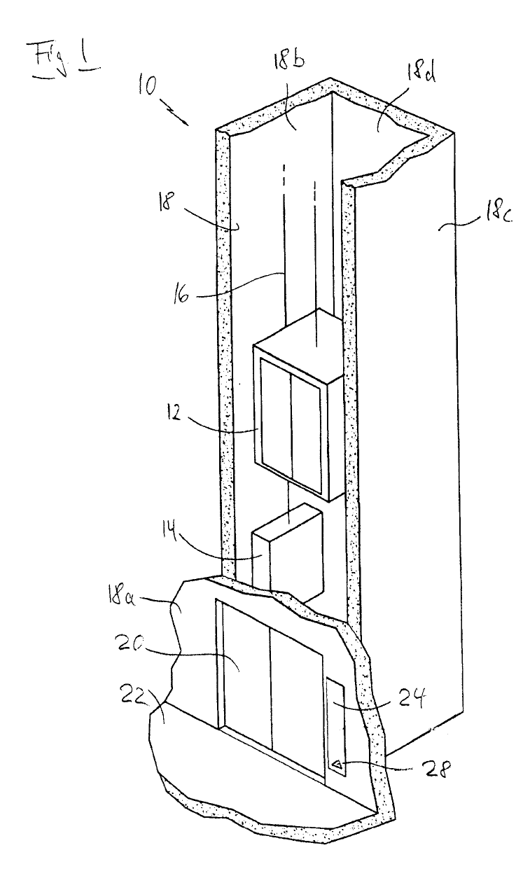

FIG. 1 shows an elevator system in which an embodiment of the invention may be employed;

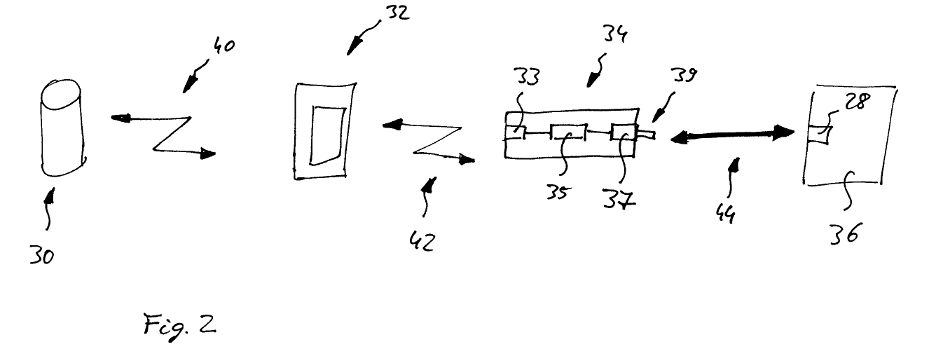

FIG. 2 shows a schematic illustration of a system for updating the software of an elevator system according to an exemplary embodiment of the invention.

FIG. 1 shows an elevator system 10 according to an embodiment in a schematic and simplified perspective view. The elevator system 10 comprises an elevator car 12 and a counterweight 14 connected by a tension member 16 in the configuration of a rope or belt (the tension member 16 is only indicated schematically in FIG. 1). The tension member 16 is driven by a an elevator drive, e.g. a traction drive, which is not shown in FIG. 1, such as to move car 12 and counterweight 14 along a hoistway 18. Although the top part of the hoistway 18 is not shown in FIG. 1, in this embodiment, the elevator drive is located in the top part of the hoistway above the highest landing. It. however, also can be arranged elsewhere, e.g. on elevator car itself. Elevator car 12 and counterweight 14 move along guide rails which are also not shown in FIG. 1. Hoistway 18 has an essentially rectangular cross section and is surrounded by four vertically extending side walls three of which (left side wall 18b, right side wall 18c, back wall 18d) are shown in FIG. 1. The front wall of the hoistway 18 is omitted in FIG. 1 to show the elevator car 12 and the counterweight 14. Only at the lowest landing 22 a portion of front wall 18a is visible with a landing door 20 being formed in front wall 18a. Not shown is a hall operating panel for entering hall calls. The front wall 18a will have a similar configuration at other landings.

Different from the other landings, at the lowest landing 22 a control board 24 is provided in the front wall 18a of the hoistway 18. The control board 24 may be used for activating a software update operation mode by operating a software update activation switch, as described in further detail below. Control board 24 may be closed by a front panel (not shown) which is itself locked by a key lock. The key lock may be opened by inserting a suitable key into the key hole of key lock. Once the front panel is opened, a connector 28 is accessible, allowing to connect a mobile updating device, which is not shown in FIG. 1, but which will be described in more detail with reference to FIG. 2, with the elevator system 10.

It is not required to arrange the control board 24 at the lowest landing 22. Alternative to the embodiment shown in FIG. 1, the control board 24 may be located at any landing or in the vicinity of the elevator 10 in other embodiments. Even more than one control board 24 might be provided, although typically one control board 24 will be sufficient to allow for a software update in a safer manner.

In some embodiments, the control board 24 may be a separate control board 24 exclusively providing the function of activating the software update operation mode. In other embodiments, the connector 28 for updating the software may be included in a control board 24, which is used for providing other functions, as well. In one example, as shown in FIG. 1, the control board 24 is used for activation of emergency electrical operation of the elevator and includes an emergency electrical operation switch. Operation of the electrical operation emergency switch permits controlling movement of the elevator car 12 manually by operating respective manual operation switches or buttons provided on the control board 24. In normal operation, the control board 24 is inactive.

FIG. 2 schematically illustrates the data transmission from a server 30 to a control unit 36 employing a mobile updating device 34 according to an embodiment of the invention.

The software, which is to be used for the update, is stored on a server 30, which might be situated in a factory or maintenance center. The software may be stored on the server in encrypted form, or it may be encrypted before it is transferred from the server 30 via a first (long range) data transmission 40 to a communication device 32. The communication device 32 may be a commercial communication device 32, such as a commercially available smartphone, tablet or (mobile) PC. The first data transmission 40 may include the transmission of the data via the internet, a wireless local area network (WLAN), or a commercial telephone and/or data network including GSM, UMTS and LTE based networks.

The communication device 32 in particular may be configured for running an appropriate software (“App”), which allows a user to establish a data connection between the communication device 32 and the server 30, to identify and authorize himself and to select the appropriate software for download.

The communication device 32 is further configured for establishing a further data connection 42 with a mobile updating device 34 for transmitting the data, which has been downloaded from the server 30 and which is still encrypted, to the mobile updating device 34.

The data may be transferred from the communication device 32 to the mobile updating device 34 via a cable, e.g. a USB cable, or wireless, e.g. using WLAN, Bluetooth® and/or a similar technology.

The mobile updating device 34 comprises at least one first data transmission interface 33, which is configured for establishing a data connection 42 with the communication device 32 in order to exchange data with the communication device 32.

In an embodiment, the mobile updating device 34 may comprise more than one first data transmission interface 33, each of the first data transmission interfaces 33 being configured for a different type of data transmission protocol.

Optionally, at least one of the first data transmission interfaces may be configured for connecting with the internet. The internet provides an inexpensive and widely available means for receiving the data to be updated. The at least one first data transmission interface in particular may be configured for establishing a WLAN connection or for connecting via a commercial telephone and/or data network including GSM, UMTS and LTE based networks in order to establish the desired connection with the internet. WLAN, GSM, UMTS and LTE networks are widespread and a suitable data transmission interface may be realized at low costs with standardized electronic components.

The mobile updating device 34 further comprises a decryption unit 35, which is configured for decrypting the encrypted data, received by the at least one first data transmission interface 33. The decryption unit 35 in particular may be configured for using a secret key stored within mobile updating device 34 for decrypting the encrypted data, in particular encrypted data which has been encrypted with a public key.

The decryption unit 35 further may be configured for verifying the integrity of the received data in order to ensure that only authorized software is installed. The decryption unit 35 in particular may use a public key for checking integrity of received data, which has been signed with a corresponding private key.

The mobile updating device 34 also comprises at least one second data transmission interface 37, which is configured to connect with the control unit 36 of the elevator system 10 providing a data connection 44 for transmitting the decrypted date to the control unit 36. The decrypted data in particular is transferred via the connector 28, which is provided at the at the control board 24 and connected with the control unit 36.

The connector 28 in particular may be provided in the form of a USB-socket. In this case, at least one second data transmission interface 37 of the mobile updating device 34 is provided with a USB plug 39 for connecting with the USB socket. The mobile updating device 34 in particular may be provided in the form of an USB stick, comprising a suitable plug 39 to be plugged into the connector 28. The mobile updating device 34 may be provided with power from the control unit 36 via the connector 28.

Instead of USB another suitable commercial or proprietary protocol may be used. As the data is not encrypted when transferred from the mobile updating device 34 to the control unit 36, preferably a wire-bound connection 44 between the mobile updating device 34 to the control unit 36 is used in order to avoid the unencrypted data from being unauthorizedly intercepted.

The at least one second data transmission interfaces in particular may be configured for transmitting the data employing a proprietary protocol. A proprietary protocol may be adapted specifically to the actual needs for optimizing the data transfer. It further may provide enhanced security, as data transmitted by a proprietary protocol may not be intercepted with standardized commercial devices.

In the embodiment shown in FIG. 2, the communication device 32 and the mobile updating device 34 are provided as two different entities with a data connection 42 therebetween.

Such a configuration allows to use an arbitrary communication device 32, in particular a commercially available communication device 32, such as a smartphone, a tablet or (mobile) PC, for receiving the encrypted data from the server 30.

In an alternative embodiment, the mobile updating device 34 is formed integrally with the communication device 32, providing a single device, which is capable of receiving encrypted data from a server 30, decrypting said data, and transmitting the decrypted data directly to the control unit 36 of the elevator system 10. Thus, a mechanic may be equipped with a single integrated device for updating the software of the control unit 36.

### Optional Features:

A number of optional features are set out in the following. These features may be realized in particular embodiments, alone or in combination with any of the other features:

In an embodiment at least one of the first and second data transmission interfaces is configured for a wireless transmission of the data. This allows a convenient transmission of the data without the need of establishing a wired connection.

In an embodiment at least one of the first and second data transmission interfaces is configured for a wire-bound transmission of the data. A wire-bound connection is very safe, as it is much more difficult to intercept the transmitted data from wire-bound connection than from a wireless connection.

In an embodiment at least one of the first and second data transmission interfaces is configured for transmitting the data using a commercial protocol/standard such as WLAN, Bluetooth®, or USB. Interfaces for transferring data using a commercial protocol/standard are easy to produce at low costs from commercially available electronic components. Using a standard protocol further allows the mobile updating device to exchange data with standardized commercial devices.

In an embodiment at least the first data transmission interface is configured for connecting with the internet. The internet provides an inexpensive and widely available means for receiving the data to be updated. The first data transmission interface in particular may be configured for establishing a WLAN connection or for connecting via a commercial telephone and/or data network including GSM, UMTS and LTE based networks in order to establish the desired connection with the internet. WLAN, GSM, UMTS and LTE networks are widespread and a suitable data transmission interface may be realized at low costs with standardized electronic components.

In an embodiment at least one of the first and second data transmission interfaces is configured for transmitting the data employing a proprietary protocol. A proprietary protocol may be adapted specifically to the actual needs for optimizing the data transfer. A proprietary protocol further may provide enhanced security, as data transmitted by means of a proprietary protocol usually cannot be intercepted easily using standardized commercial devices.

In an embodiment the decryption unit is configured for decrypting encrypted data, which has been encrypted using a public key, by employing a corresponding secret key. Using a pair comprising a public key and a corresponding private key provides a very safe data encryption.

In an embodiment the decryption unit is configured for checking a signature of the received encrypted data in order to ensure that no malware is installed on the control unit. Checking a signature of the received data thus enhances the (operational) safety of the elevator system even further.

A system for updating the software of a people conveyor comprises: a mobile updating device according to an embodiment of the invention and a commercial communication device, which is configured for receiving the encrypted data and transmitting the encrypted data to the mobile updating device.

With such a system, a user may use his “normal” commercial communication device for updating the software of the control unit. The mobile updating device may be produced for reduced costs, as some of the functionalities, e.g. the functionalities of connecting with the server and selecting the appropriate software, are realized by the communication device. Thus, the mobile updating device e.g. may be produced without a display.

In order to provide the necessary functionalities, the commercial communication device may be provided with an appropriate software, which in particular may be an “App”, for selecting, receiving and transmitting the encrypted data.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention include all embodiments falling within the scope of the dependent claims.

### REFERENCES

10 people conveyor/elevator system
12 elevator car
14 counterweight
16 tension member
18 hoistway
18a front sidewall
18b left sidewall
18c right sidewall
18d rear sidewall
20 landing door
22 lowest landing
24 control board
28 connector
30 server
32 communication device
33 first data transmission interface
34 mobile updating device
35 decryption unit
36 control unit
37 second data transmission interface
39 plug
40 first (long range) data transmission connection
42 second (short range) data transmission connection
44 third data transmission connection

1. Mobile updating device (34) for updating the software of a people conveyor (10), the mobile updating device (34) comprising:
(A) a first data transmission interface (33), which is configured for receiving encrypted data;
(B) a decryption unit (35), which is configured for decrypting the received encrypted data; and
(C) a second data transmission interface (37), which is configured for connecting with a control unit (36) of the people conveyor (10) and to transmit the decrypted data to the control unit (36).

2. Mobile updating device (34) of claim 1, wherein at least one of the first and second data transmission interfaces (33, 37) is configured for a wireless transmission of the data.

3. Mobile updating device (34) of claim 1, wherein at least one of the first and second data transmission interfaces (33, 37) is configured for a wire-bound transmission of the data.

4. Mobile updating device (34) of claim 1, wherein at least one of the first and second data transmission interfaces (33, 37) is configured for transmitting the data employing a commercial protocol such as WLAN, Bluetooth®, or USB.

5. Mobile updating device (34) of claim 1, wherein at least one of the first and second data transmission interface (33, 37) is configured for transmitting the data employing a proprietary protocol.

6. Mobile updating device (34) of claim 1, wherein the first data transmission interface (33) is configured for connecting with the internet.

7. Mobile updating device (34) of claim 1, wherein the decryption unit (35) is configured for decrypting encrypted data, which has been encrypted using a public key, by employing a secret key.

8. Mobile updating device (34) of claim 1, wherein the decryption unit (35) is configured for checking a signature of the received encrypted data.

9. System for updating the software of a people conveyor (10), the system comprising:
(a) a mobile updating device (34) according to claim 1; and
(b) a commercial communication device (32), which is configured for receiving the encrypted data and transmitting the encrypted data to the mobile updating device (34).

10. System for updating the software of a people conveyor (10) of claim 9, wherein the commercial communication device (32) is provided with a software for selecting, receiving and transmitting the encrypted data.

11. System for updating the software of a people conveyor (10) of claim 9, wherein at least one of the mobile updating device (34) and the commercial communication device (32) comprises means for checking the identity of a user operating the communication device (32).

12. Method of updating the software of a people conveyor (10) comprising the steps of:
(a) establishing a data transmission connection (40, 42) between an update server (30) and a mobile updating device (34);
(b) transmitting encrypted data from the update server (30) to the mobile updating device (34);
(c) decrypting the data by the mobile updating device (34);
(d) establishing a data transmission connection (44) between the mobile updating device (34) and the people conveyor (10); and
(e) transmitting the decrypted data from the mobile updating device (34) to the people conveyor (10).

13. Method of updating the software of a people conveyor (10) according to claim 12, further comprising the step of verifying the identity of a user, the mobile updating device (34) and/or the people conveyor (10).

14. Method of updating the software of a people conveyor (10) according to claim 12, further comprising the step of verifying the integrity of the transmitted data.
